(19) United States
(12) Patent Application Publication
(10) Pub. No.: US 2023/0308547 A1
(43) Pub. Date: Sep. 28, 2023

(54) SATELLITE BACKHAUL CHARGING FUNCTION INTERFACE FOR TRANSMITTING CHARGING DATA REQUEST WITH INDICATION OF NON-TERRESTRIAL NETWORK BACKHAUL

(71) Applicant: Nokia Technologies Oy, Espoo (FI)

(72) Inventors: Hannu Petri HIETALAHTI, Kiviniemi (FI); Laurent THIEBAUT, Antony (FR); Joao Antonio PEREIRA RODRIGUES, Lisbon (EG)

(21) Appl. No.: 18/187,815

(22) Filed: Mar. 22, 2023

Related U.S. Application Data
(60) Provisional application No. 63/269,964, filed on Mar. 25, 2022.

(51) Int. Cl. H04M 15/00

(52) U.S. Cl. CPC H04M 15/8016; H04M 15/66

(57) ABSTRACT

Methods and apparatuses for providing charging information related to a satellite backhaul over an interface to a charging function are disclosed. For example, a method may include sending a charging data request to a charging function of a core network. The charging data request can include an identifier configured to indicate that a non-terrestrial network backhaul has been used for sending data traffic from a radio access network to a core network. The method may also include receiving a charging data response from the charging function in response to the charging data request.

### RELATED APPLICATIONS

This application claims the benefit of priority of U.S. Provisional Patent Application No. 63/269,964 filed Mar. 25, 2023, which is hereby incorporated by reference as if reproduced in its entirety.

### FIELD

Some example embodiments of the present disclosure may generally relate to communications, and in particular to mobile or wireless telecommunication systems, such as Long Term Evolution (LTE), fifth generation (5G) or new radio (NR) telecommunication systems, or other telecommunications systems. For example, certain example embodiments of the present disclosure may generally relate to systems and/or methods for providing charging information related to a satellite backhaul to a charging function.

### BACKGROUND

Examples of mobile or wireless telecommunication systems may include a Universal Mobile Telecommunications System (UMTS), a Long Term Evolution (LTE) telecommunication system, a LTE-Advanced (LTE-A) telecommunication system, a LTE-A Pro telecommunication system, and/or a fifth generation (5G) or new radio (NR) telecommunication system. 5G telecommunication systems refer to the next generation (NG) of radio access networks and a network architecture for the core network. A 5G telecommunication system is mostly built on a 5G new radio (NR), but a 5G telecommunication system can also built on other radio access technologies, such as LTE. It is estimated that 5G NR provides bitrates on the order of 10-20 Gbit/s or higher, and can support at least service categories such as enhanced mobile broadband (eMBB) and ultra-reliable low-latency-communications (URLLC) as well as massive machine type communication (mMTC). 5G NR is expected to deliver extreme broadband and ultra-robust, low latency connectivity and massive networking to support the Internet of Things (IoT). With IoT and machine-to-machine (M2M) communication becoming more widespread, there will be a growing need for networks that meet the needs of lower power, low data rate, and long battery life. The next generation radio access network (NG-RAN) represents the RAN for 5G NR, which can provide both 5G NR and LTE (and LTE-Advanced) radio access. It is noted that, in a NG-RAN, radio access nodes that can provide radio access functionality to a user equipment (i.e., similar to the Node B, NB, in a UTRAN or the evolved NB, eNB, in LTE) may be named next-generation NB (gNB) when built on 5G NR and may be named next-generation eNB (NG-eNB) when built on E-UTRA.

### SUMMARY

An embodiment of the present disclosure may be directed to an apparatus. The apparatus can include at least one processor and at least one memory comprising computer program code for a session management function. The at least one memory and computer program code for a session management function can be configured, with the at least one processor, to cause the apparatus at least send a charging data request to a charging function of a core network. The charging data request can include an identifier configured to indicate that a non-terrestrial network backhaul has been used for sending data traffic from a radio access network to a core network. The charging data request can also include information indicating an orbit altitude of the non-terrestrial network backhaul. The charging data request can also include information on the average delay incurred by the non-terrestrial backhaul network. The at least one memory and computer program code can also be configured, with the at least one processor, to cause the apparatus at least to receive a charging data response from the charging function in response to the charging data request. The charging data response can include a quota to be applied to, or that is granted to, a consumed service, which may be in units such as megabytes (MB), gigabytes (GB), or the like.

An embodiment of the present disclosure may be directed to an apparatus. The apparatus can include at least one processor and at least one memory comprising computer program code for a charging function. The at least one memory and computer program code can be configured, with the at least one processor, to cause the apparatus at least to receive a charging data request from a session management function of a core network. The charging data request can include an identifier configured to indicate that a non-terrestrial network backhaul has been used for sending data traffic from a radio access network to a core network. The charging data request can also include information indicating an orbit altitude of the non-terrestrial network backhaul. The charging data request can also include information on the average delay incurred by the non-terrestrial backhaul network. The at least one memory and computer program code can further be configured, with the at least one processor, to cause the apparatus at least to send a charging data response to the session management function in response to the charging data request. The charging data response can include a quota to be applied to, or that is granted to, a consumed service, which may be in units such as megabytes (MB), gigabytes (GB), or the like.

An embodiment of the present disclosure may be directed to a method performed by a session management function of a core network. The method may include sending a charging data request to a charging function of a core network. The charging data request can include an identifier configured to indicate that a non-terrestrial network backhaul has been used for sending data traffic from a radio access network to the core network. The charging data request can also include information indicating an orbit altitude of the non-terrestrial network backhaul. The charging data request can also include information on the average delay incurred by the non-terrestrial backhaul network. The method may also include receiving a charging data response from the charging function in response to the charging data request. The charging data response can include a quota to be applied to, or that is granted to, a consumed service, which may be in units such as megabytes (MB), gigabytes (GB), or the like.

An embodiment of the present disclosure may be directed to a method performed by a charging function. The method may include receiving a charging data request from a session management function of a core network. The charging data request can include an identifier configured to indicate that a non-terrestrial network backhaul has been used for sending data traffic from a radio access network to the core network. The charging data request can also include information indicating an orbit altitude of the non-terrestrial network backhaul. The charging data request can also include information on the average delay incurred by the non-terrestrial backhaul network. The method may also include sending a charging data response to the session management function in response to the charging data request. The charging data response can include a quota to be applied to, or that is granted to, a consumed service, which may be in units such as megabytes (MB), gigabytes (GB), or the like.

An embodiment of the present disclosure may be directed to an apparatus implementing a session management function of a core network. The apparatus may include means for sending a charging data request to a charging function of a core network. The charging data request can include an identifier configured to indicate that a non-terrestrial network backhaul has been used for sending data traffic from a radio access network to the core network. The charging data request can also include information indicating an orbit altitude of the non-terrestrial network backhaul. The charging data request can also include information on the average delay incurred by the non-terrestrial backhaul network. The apparatus may also include means for receiving a charging data response from the charging function in response to the charging data request. The charging data response can include a quota to be applied to, or that is granted to, a consumed service, which may be in units such as megabytes (MB), gigabytes (GB), or the like.

An embodiment of the present disclosure may be directed to an apparatus implementing a charging function. The apparatus may include means for receiving a charging data request from a session management function of a core network. The charging data request can include an identifier configured to indicate that a non-terrestrial network backhaul has been used for sending data traffic from a radio access network to a core network. The charging data request can also include information indicating an orbit altitude of the non-terrestrial network backhaul. The charging data request can also include information on the average delay incurred by the non-terrestrial backhaul network. The apparatus may also include means for sending a charging data response to the session management function in response to the charging data request. The charging data response can include a quota to be applied to, or that is granted to, a consumed service, which may be in units such as megabytes (MB), gigabytes (GB), or the like.

### BRIEF DESCRIPTION OF THE DRAWINGS

For proper understanding of example embodiments, reference should be made to the accompanying drawings, wherein:

FIG. 1 illustrates a core network informing a charging function of an observed satellite backhaul delay, according to certain embodiments;

FIG. 2A illustrates a first part of a common data structure of a charging data request, according to certain embodiments;

FIG. 2B illustrates a second part of a common data structure of a charging data request, according to certain embodiments;

FIG. 3 illustrates an example flow diagram of a method, according to an embodiment;

FIG. 4 illustrates another example flow diagram of a method, according to an embodiment;

FIG. 5 illustrates a further system according to certain embodiments;

FIG. 6 illustrates a further system according to certain embodiments; and

FIG. 7 illustrates an example block diagram of a mobile or wireless telecommunication system, according to an embodiment.

### DETAILED DESCRIPTION

It will be readily understood that the components of certain example embodiments, as generally described and illustrated in the figures herein, may be arranged and designed in a wide variety of different configurations. Thus, the following detailed description of some example embodiments of systems, methods, apparatuses, and computer program products for providing charging information related to a satellite backhaul over an interface to a charging function, is not intended to limit the scope of certain embodiments but is representative of selected example embodiments.

The features, structures, or characteristics of example embodiments described throughout this specification may be combined in any suitable manner in one or more example embodiments. For example, the usage of the phrases “certain embodiments,” “some embodiments,” or other similar language, throughout this specification refers to the fact that a particular feature, structure, or characteristic described in connection with an embodiment may be included in at least one embodiment. Thus, appearances of the phrases “in certain embodiments,” “in some embodiments,” “in other embodiments,” or other similar language, throughout this specification do not necessarily all refer to the same group of embodiments, and the described features, structures, or characteristics may be combined in any suitable manner in one or more example embodiments.

Certain embodiments may have various aspects and features. These aspects and features may be applied alone or in any desired combination with one another. Other features, procedures, and elements may also be applied in combination with some or all of the aspects and features disclosed herein.

Additionally, if desired, the different functions or procedures discussed below may be performed in a different order and/or concurrently with each other. Furthermore, if desired, one or more of the described functions or procedures may be optional or may be combined. As such, the following description should be considered as illustrative of the principles and teachings of certain example embodiments, and not in limitation thereof.

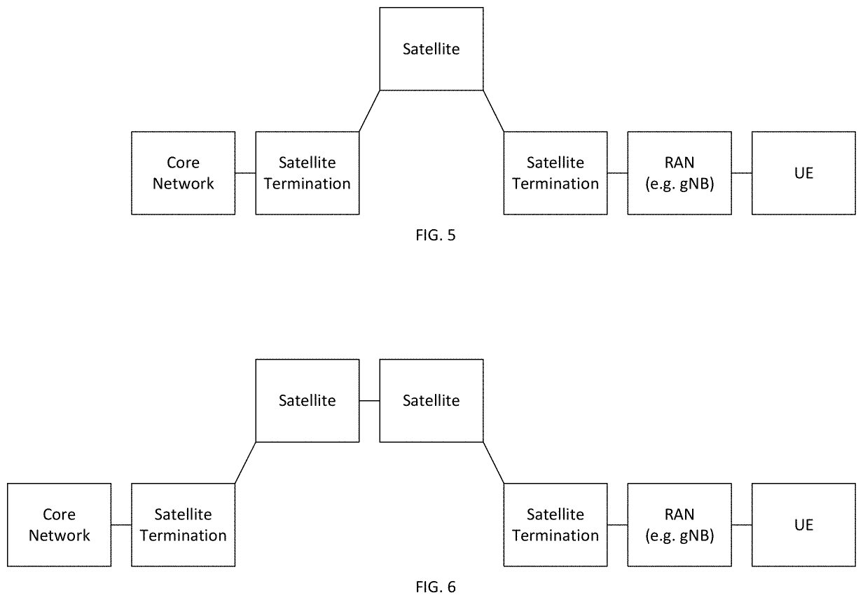

FIG. 5 illustrates a wireless telecommunication system that includes a satellite backhaul between a third generation partnership project (3GPP) radio access network (RAN) and a core network, such as a fifth generation core (5 GC) network, according to certain embodiments. As shown in FIG. 5, the satellite backhaul can include a first satellite termination (e.g. first satellite ground station), a satellite, and a second satellite termination (e.g. second satellite ground station). The core network is connected to the first satellite termination and the first satellite termination is connected to the satellite. The satellite is connected to the second satellite termination. In turn, the second satellite termination is connected to a radio access network node, such as a next generation Node B (gNB), of the 3GPP RAN. The RAN node can provide radio access to a user equipment (UE).

FIG. 5 more particularly provides an example of a 3GPP RAN that can serve UE(s), including the UE. For example, the radio access network node may be an evolved Node B in the case where the 3GPP RAN is a LTE RAN or a gNB in the case where the 3GPP RAN is NG-RAN. The UE(s) could be, for example, mobile phones, wireline residential gateways (RGs), Internet of things (IoT) cellular devices, or the like. The RAN node could be located in a remote location that requires the usage of a satellite backhaul to connect the RAN node to the core network. The satellite backhaul can carry an N2 and N3 interfaces between the RAN and the core network but could also carry other interfaces, such as an N4 interface between a session manager of the core network, such as a session management function (SMF) in the case of 5 GC, and a user plane (UP) handling function that is co-located with the 3GPP RAN (e.g. a 3GPP terrestrial RAN). An example of an UP handling function may be a user plane function (UPF) in case of 5 GC. The satellite backhaul can include two satellite link terminations and at least one satellite, thus two satellite links. Certain embodiments may be applied to low earth orbit (LEO) or medium earth orbit (MEO) satellite whose position with regard to the Earth is not constant. Although a geosynchronous satellite, by contrast, may have a relatively fixed position, the distance-dependent latency experienced due to round trip time in communication using, such a satellite may make it less useful for live communication.

FIG. 6 illustrates a similar wireless telecommunication system to the wireless telecommunication system in FIG. 5. One difference between the wireless telecommunication system of FIG. 6 and that of FIG. 5 is that the satellite backhaul includes two satellites connected to one another.

FIG. 6 more particularly provides an example of a situation where the delay of the satellite backhaul may vary. In a starting situation, illustrated by FIG. 5, the satellite backhaul may involve two satellite link terminations and only a single satellite. Then due to various circumstances, the same satellite may not be able to continue to connect to both the first and second satellite terminations. For example, such circumstances may arrive due to the following events: mobility of the original satellite on its orbit, and/or mobility of the RAN, such as when the RAN and the UE(s) the RAN is serving are on a vehicle such as a boat. In such a case, the satellite backhaul may involve two satellite link terminations and, for example, two satellites. Consequently, there may be three satellite links. The addition of the inter-satellite link between the two satellites may increase dramatically the delay of the whole satellite backhaul.

Satellite backhaul implementations may need to address the fact that when satellites are moving with respect to the surface of the Earth, a variable backhaul delay may arise. If a geosynchronous satellite were used, and if the two satellite terminations are at fixed locations, then the backhaul delay may be relatively constant. The backhaul delay may be dominated by the propagation delay from a ground- or water-based satellite termination at fixed locations to a satellite, the processing time in the satellite, and the propagation delay back to Earth. The variation in delay may be due to a different distance from the satellite terminations to the satellite, or, for example, when satellite backhaul connection with an inter-satellite link is used as shown in FIG. 6. In the case of FIG. 6, the delay may include propagation delay from Earth to space, then two processing delays at the two satellites, and propagation delay between the two satellites. An inter-satellite link can be used to relay data traffic from one satellite to another satellite in a satellite backhaul that includes multiple satellites to send the data traffic to a satellite that covers a target satellite termination (e.g., a satellite ground station). For instance, if there is a satellite termination (e.g., satellite ground station) on each side of an ocean, then UEs on board a ship crossing the ocean may experience variable delay over the satellite backhaul when the number of satellites in the satellite backhaul that leads to the satellite that covers the present ship position is changed. There may be a satellite termination on the ship, such as a gNB mounted on the ship. When the ship is closer to one side of the ocean, the signal path may be from the UE to the gNB on the ship, then up to a satellite, and then down to a satellite termination in a ground station on the near side of the ocean. When the ship is away from the shore, the same satellite may not cover the ship and the shore, and thus there may be an inter-satellite link. As the ship approaches the opposite shore, eventually a satellite may serve the ship and a satellite termination at a ground station on the opposite shore. For example, in the situation illustrated by FIG. 5 only a relatively short delay may occur, whereas in the situation illustrated by FIG. 6, a relatively long delay may occur. The number of inter-satellite links that data traffic traverses increases when the ship is sailing further away from the coast, only to start decreasing again at halfway point. The varying distance covered in the satellite backhaul leads to varying delay that can be observed by a user equipment. Additionally, other aspects of the satellite coverage, such as the number of satellites in a constellation of satellites, may affect the number of inter-satellite links that are used. Although ships are used as an example, the same principle may apply to other situations where a gNB does not have a wired connection to the Internet or a similar wired network backbone. Thus, a gNB on an island or train may have a satellite termination. Other implementations and use cases are permitted.

In order for proper charging of data transfer, including data transfer over satellites, there may be an interface between a charging management function and a session management function, known as the N40 interface. The N40 interface is defined in 3GPP technical specification (TS) 32.255 for interactions between a home session management function (H-SMF) and home charging function (H-CHF) of a core network of a HPLMN or a visited session management function (V-SMF) and a visited charging function (V-CHF) of a core network of a VPLMN.

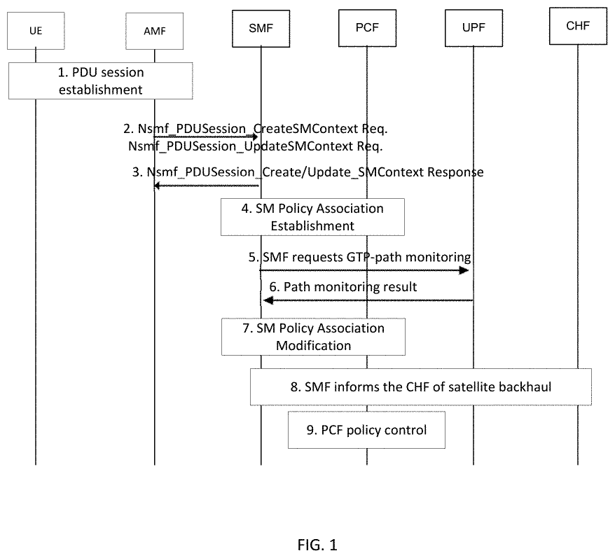

Satellite backhaul can be identified based on what is referred to as satellite backhaul category. Satellite backhaul can be viewed as an example of non-terrestrial network backhaul and satellite backhaul category can be view as an example of non-terrestrial backhaul category. Satellite backhaul category corresponds to an orbit altitude of the satellite backhaul (i.e., the orbit altitude of the satellites included in the satellite backhaul), for example a Low Earth Orbit (LEO), Medium Earth Orbit (MEO), Geostationary Orbit (GEO) or (OTHERSAT) for other orbits. The satellite backhaul category can be used as the basis for an estimate of the delay of the satellite backhaul but the satellite backhaul category may not be sufficiently accurate to determine the actual satellite backhaul delay in milliseconds. Information related to satellite backhaul category can be used to improve accuracy on how the rating, and quota is applied/granted to a consumed service (which is included in Charging Data Response Message sent by the CHF to SMF (see FIG. 1). The information related to Satellite Backhaul Category is quite important due to the variance (statistics data for network analysis) that may exist whilst data for a service is transported through the satellite backhaul. It may nevertheless also, as discussed later, not be precise enough as the delay incurred by the satellite backhaul (otherwise referred to as satellite backhaul delay) may vary a lot within a single satellite backhaul category when multiple satellite links (e.g., links from satellite terminations to a satellite and inter-satellite links) become needed to reach a terrestrial RAN.

The quality of service (QoS) for a PDU session can be adjusted based on a measured backhaul delay. Adjusting the QoS for a PDU session based on measured backhaul delay can provide dynamically varying QoS for the PDU session.

However, merely adjusting QoS for a PDU session does not address charging, network statistics and possible reconciliation of user complaints, as none of the QoS data gets stored in a way that can be used for charging or similar purposes. Without data on network statistics and the like, it may not be possible to identify what delay class truly corresponds to the provided service. Thus, it may not be possible for a network operator to apply different tariffs depending on true delay class that has been offered for a subscriber (e.g., customer). If there are customer complaints, the network operator does not have access to statistics, which may otherwise be used to debug the problem or to evaluate the validity of the customer complaints. Moreover, a network operator may desire to charge customers differently based on the true delay class.

FIG. 1 illustrates an example diagram depicting signaling between various network functions of a core network for informing a charging function of an observed satellite backhaul delay, according to some embodiments. Thus, certain embodiments provide a method and associated devices that can collect information related to satellite backhaul category and a true observed satellite backhaul delay and provide the information related to the satellite backhaul category and the true observed satellite backhaul delay the to a charging function. Collection of information on satellite backhaul category and an observed satellite backhaul delay may enable a network operator differentiation of charging based on the observed backhaul satellite delay, statistics data for network analysis, and network statistics information allowing assessment of customer complaints and understanding of technical reasons for such complaints.

In reference architecture specified in Release 17 (Rel 17) of the 3GPP TS 23.501 and 3GPP TS 23.502, an access management function (AMF) can be configured with the awareness of satellite backhaul categories. The AMF can inform the SMF of satellite backhaul category that is being used when a protocol data unit (PDU) session is established between a UE and an AMF serving the UE and after a change to the backhaul satellite backhaul category or handover causes a different backhaul to be used. When the UE is roaming, a SMF of a visiting PLMN (e.g., a V-SMF) can relay the satellite backhaul category to the SMF of a home PLMN (e.g. a H-SMF). The PCF can be informed of satellite backhaul category as the SMF can include the satellite backhaul category in SM policy association establishment request. Based on this knowledge, the policy charging function (PCF) can set the QoS policies for the PDU session accordingly.

Awareness of QoS changes can adapt the approach of providing a satellite backhaul category to the dynamic delay requirement that may be needed for Release 18 (Rel-18) of the 3GPP standard. The awareness of variable delay can be obtained by re-using the capability for the SMF to request QoS monitoring from a UPF that is specified in 3GPP TS 23.501, clause 5.33.3.3.

An N3 interface can be provided between RAN element (e.g., a gNB) and a user plane function (UPF). In addition to the already specified use cases where the SMF informs the PCF of the satellite backhaul category, the SMF can be enhanced to request the UPF measure the N3 delay using an echo request/response procedure and to inform the PCF of not only satellite backhaul category but also the observed delay determined using an echo request/response procedure.

Referring again to FIG. 1, at 1, a non-access stratum (NAS) PDU session establishment process can be triggered by a user equipment (UE) and a PDU session establishment request can be sent by the UE towards an AMF serving the UE. The AMF serving the UE is part of a core network, such as a fifth-generation core network (5 GC). Various events can occur in which the AMF serving the UE can determine a satellite backhaul category. Example events can include: during the PDU session establishment process, PDU session modification, service request or handover. These various events may rely on usage of NG-RAN with different satellite backhaul categories (or possibly usage of RAN with no satellite backhaul). The selection of satellite backhaul category may depend on e.g. an AMF configuration associating the NG RAN interface with a satellite backhaul category.

Then, at 2 and 3, the AMF can send a request to a SMF to create (or update) a context for the PDU session and can receive a response that includes the created (or updated) context for the PDU session. More particularly, the AMF can inform the SMF that satellite backhaul is used for the PDU session by including information on the Satellite Backhaul Category in a Nsmf_PDUSession_CreateSMContext message or in a Nsmf_PDUSession_UpdateSMContext message as specified in 3GPP TS 23.502, clause 4.3.2.2. The SMF can respond by sending a Nsmf_PDUSession_CreateSMContext Response message or Nsmf_PDUSession_UpdateSMContext Response.

At 4, the SMF and PCF can perform a session management (SM) policy association establishment process. More particularly, the SMF can inform the PCF of the satellite backhaul by including satellite backhaul category in a Npcf_SMPolicyControl_Update request sent during the SM policy association establishment process as specified in 3GPP TS 23.501, clause 4.16.4. The PCF can take the initial policy decision based on the information that the PCF has received so far, such as the satellite backhaul category. As mentioned above, the satellite backhaul category may provide a coarse estimate of backhaul delay. At this point, the PCF may not yet be aware of any dynamic changes in the observed backhaul delay.

At 5, the SMF can request a user plane function (UPF) perform GTP-u path monitoring. Since satellite backhaul is used to send data from a RAN to a core network, the SMF can send a request for general packet radio service (GPRS) tunneling protocol (GTP) for user data (GTP-U) path monitoring to the UPF as specified in 3GPP TS 23.501, clause 5.33.3.3. Satellite backhauling and the need for GTP-u path monitoring may apply to multiple interfaces. For example, explained above, satellite backhauling may apply over N3 interface (e.g. the interface between a RAN and a first UPF). Satellite backhauling may also apply over an N9 interface (the interface between the first UPF and a second UPF) to cope with following network deployment scenario: a RAN and a first UPF supporting local data traffic routing on, for example, a boat, can be deployed on the boat. The RAN deployed on the boat may use a satellite backhaul to send data traffic to the second UPF which is deployed in a core network.

At 6, the UPF can respond to the request for GTP-U path monitoring with a GTP-U path monitoring result. The SMF can receive the response that includes a GTP-U path monitoring result indicating the observed delay. The delay may be observed by using a reply/response echo procedure, over GTP-u as described above. Other mechanisms for determining delay are also permitted. The echo procedure or other mechanisms may be used identify the observed satellite backhaul delay as a one-way delay through the satellite backhaul. The response received at 6 can be received during the PDU session establishment process or (if GTP-U path monitoring by the UPF takes too much time) after the PDU session establishment process has been completed.

At 7, the SMF and PCF can perform SM policy association modification. Upon receiving the observed delay from the UPF at 6, the SMF can initiate an SM policy association notification in order to inform the PCF of the satellite backhaul category and the actual observed delay.

Then, at 8, the SMF can inform the charging function (CHF) about the satellite backhaul. The SMF can inform the CHF about the satellite backhaul by sending a charging data request that includes information about the satellite backhaul category and the observed satellite backhaul delay. This information and the observed satellite backhaul delay may be used for charging, network statistics, sorting out customer complaints, as well as any other desired purpose. The SMF can asynchronously inform the CHF about the satellite backhaul at any time after having received the observed satellite backhaul delay at 6.

Finally, at 9, the PCF can perform policy control. The PCF can adjust the QoS policy for the PDU session according to observed delay, such as delay observed with respect to an N3 interface, which may be a one-way delay. The PCF may need to report the observed N3 delay to an application function (AF) for application specific reasons.

The real-time value of satellite backhaul delay measured by the core network can be sent over a service based interface (SBI) (e.g. the N40 interface) as a service operation to CHF for CHF to store its value for later use in charging, statistics and possible user complaints resolution.

More particularly, at 8, the SMF can inform the CHF of the satellite backhaul category, the observed satellite backhaul delay, and/or quality of service (QoS) parameters. The requests, responses, and other procedures described above with reference to 5, 6, 7, 8, and 9 may take place any time there is a change of satellite backhaul category. For example, procedures can take place not only at PDU session establishment but also within any procedure that involves the SMF and where the SMF is made aware of a change to the satellite backhaul category for the N3 interface that supports a PDU session. For example, the SMF may be made aware of a change of satellite backhaul category during a procedure related to the reactivation of the user plane of a PDU session or during a handover procedure.

The AMF may be configured to indicate a satellite backhaul category even though only the N2 interface is using a satellite backhaul. This may cover additional scenarios.

New information elements, fields, and/or sub-fields can be added to charging data request and charging data response to handle charging operations for the SMF at 8 of FIG. 1, in different charging scenarios, such as event-based and session-based services in online and offline charging scenarios. A common data structure for each one of the charging data request and the charging data response is specified in 3GPP TS 32.290. Certain embodiments may relate to information that is to be reported by the SMF to the CHF and information that is to be stored by CHF to a charging data record (CDR).

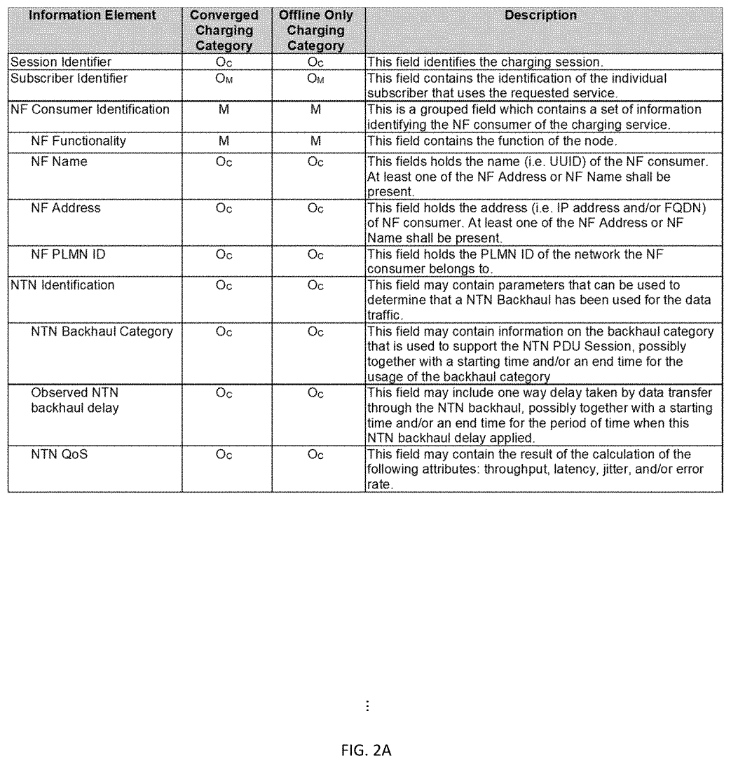

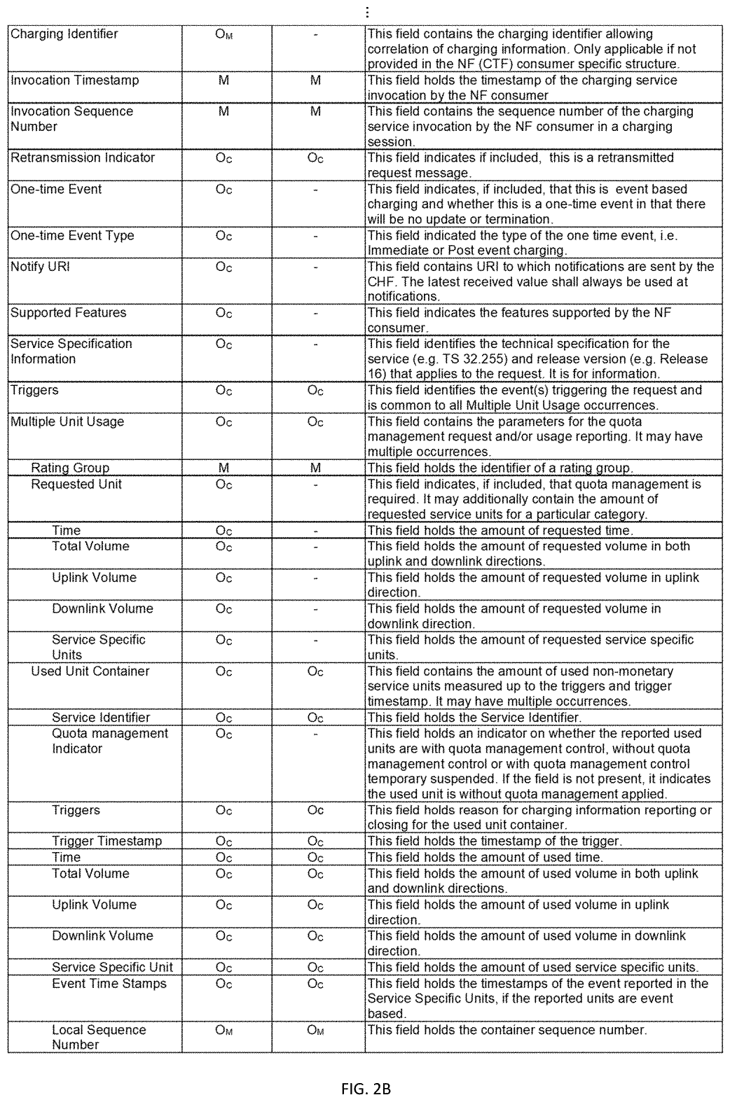

FIG. 2A illustrates an example of a first part of a common data structure of a charging data request, according to certain embodiments. The first column in FIG. 2A and FIG. 2B correspond to the data structure itself. The next two columns describe the converged charging category and offline only charge category, respectively. The last column is a description of the information element included in the data structure. FIG. 2B illustrates an example of a second part of a common data structure of a charging data request, according to certain embodiments. FIG. 2B is a continuation of the same common data structure illustrated in FIG. 2A. The common data structure of a charging data request includes information elements (i.e., fields) that identify new attributes, such as non-terrestrial network (NTN) backhaul (e.g. satellite backhaul network) attributes.

The common data structure can include a number of different information elements, each of which can have a converged charging category and possibly an offline only charging category. The right-most column of FIG. 2A and FIG. 2B provides a description, by way of example, for each information element.

For example, as shown in FIG. 2A, the information element “session identifier” can be a field in the charging data request that identifies a charging session. The information element “subscriber identifier” can be a field in the charging data request that contains the identification of the individual subscriber that uses a requested service. The information element “network function (NF) consumer identification” can be a grouped field in the charging data request that includes a set of information elements identifying the NF consumer of the charging service. For example, the NF consumer identification can include the information element “NF functionality”, NF name, NF address, and NF public land mobile network (PLMN) identifier (ID) as fields in the charging data request.

The NF functionality field can describe the function of a given NF consumer. The NF name field can hold a name, such as a universally unique identifier (UUID), of the NF consumer. It is not necessary that both the NF name and NF address be present in the NF consumer field of the data structure. The information element “NF address” can be a field in the data structure that identifies an address of the NF consumer, such as a fully qualified domain name (FQDN). The information element “NF PLMN ID” can be field can that identifies the PLMN ID of a PLMN to which the NF consumer belongs.

The information element “NTN identification” can be a group field that includes one or more parameters that can be used to determine that a NTN backhaul has been used for data traffic to which this charging data request belongs. The NTN backhaul category field can contain information on the backhaul category that is used to support the NTN PDU session. The NTN backhaul category field can also include a start time and/or end time of the usage of the backhaul category.

The observed NTN backhaul delay field may provide information indicating one way delay taken by data transferred through the NTN backhaul. The NTN backhaul delay field can also include a start time and/or end time to which the backhaul delay applies.

The NTN QoS field can include various QoS parameters. For example, the QoS parameters can include throughput, latency, jitter, and error rate. Other QoS attributes can also be included in the NTN QoS.

As shown in FIG. 2B, the data structure can also include information element “charging identifier”, which can be a field in the charging data request that contains the charging identifier for the PDU session, allowing correlation of charging information. The charging identifier field may only be used in the data structure if not already provided in an NF (CTF) consumer specific structure.

The information element “invocation timestamp” can be a field in the charging data request which includes the timestamp of when the charging service is invoked by a NF consumer. The information element “invocation sequence number” can be a field in the charging data request that contains the sequence number of the charging service invoked by the NF consumer in a charging session. The information element “retransmission indicator”, which if included, can be a field in the charging data request which indicates that the charging data request is a retransmitted charging data request.

The information element “one-time event” can be a field in the charging data request, which if included, indicate that the event is event-based charging and whether the event is a one-time event in that there will be no update to the event or termination of the event. The information element “one-time event type” can be a field in the charging data request, which if included, indicates the type of the one-time event, for example, immediate or post-event charging.

The information element “notify uniform resource indicator (URI)” can be a field in the charging data request that includes the URI to which notifications are sent by the CHF. The latest received value of satellite backhaul delay can be used for notifications.

The information element “supported features” can be a field in the charging data request that indicates the features supported by the NF consumer. The information element “service specification information” can be a field in the charging data request that identifies a technical specification for the service (e.g. 3GPP TS 32.255) and release version (for example, Release 16) that applies to the charging data request.

The information element “triggers” can be a field in the charging data request which identifies the event(s) triggering the charging data request and can be common to all multiple-unit usage occurrences.

The information element “multiple unit usage” can be a field in the charging data request that contains the parameters for the quota management request and/or usage reporting. There can be multiple occurrences of this field in the charging data request.

The information element “rating group” can be field in the charging data request that can hold the identifier of a rating group. The information element “requested unit” can be a field in the charging data request, which if included, indicates that quota management is required. The field may additionally contain the amount of requested service units for a particular category. There can be various sub-fields associated with the field for the information element “requested unit” including time, total volume, uplink volume, downlink volume, and service specific units, which can indicate the corresponding amounts.

The information element “used unit container” can be a field in the charging data request which indicates the amount of used non-monetary service units measured up to the triggers and trigger timestamp. There may be multiple occurrences of this field in the charging data request. There can be various sub-fields including service identifier, quota management indicator, triggers, trigger timestamp, time, total volume, uplink volume, downlink volume, service specific unit, event time stamps, and local sequence number. Most of these subfields would be known to a person of ordinary skill in the art and hence are not described in detail. The quota management indicator can provide an indicator of whether the reported used units are with quota management control, without quota management control or with quota management control temporary suspended. If the field is not present in the charging data request, the absence of the field can indicate that the used unit is without quota management applied.

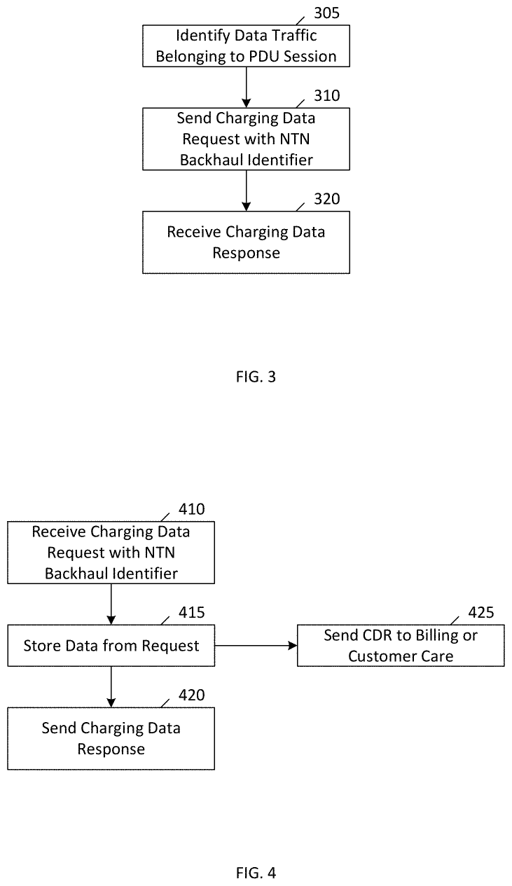

FIG. 3 illustrates an example flow diagram of a method for providing charging information related to a satellite backhaul over an interface to a charging function, according to certain embodiments. In some embodiments, the method of FIG. 3 is performed by a network function such as, for example, session management function. A session management function may be implemented on an apparatus of a core network. The session management function may be implemented in a standalone apparatus, in a blade of a multi-blade server system, or in a cloud computing system that implements several other network functions of the core network.

As illustrated in the example of FIG. 3, the method can include, at 310, sending a charging data request to a charging function of a core network. The charging data request can include an identifier configured to indicate that a non-terrestrial network backhaul (e.g. satellite backhaul) has been used for the data transferred from a RAN to the core network and possibly to indicate an average of actual observed delay and QoS change due to the non-terrestrial network backhaul (e.g. satellite backhaul). The average, for example arithmetic mean, of the observed backhaul delay can also be referred to as the actual average observed delay. The method may also include, at 305, identifying data traffic as corresponding to, for example, a particular PDU session related with usage of a non-terrestrial network backhaul (e.g., satellite backhaul). For example, if a particular PDU session uses a non-terrestrial network backhaul (e.g., satellite backhaul), then the data traffic of that PDU session can be identified at 305, and the identification can trigger suitable messaging to a charging function.

The method can also include, at 320, receiving a charging data response from the charging function in response to the charging data request. The method at 310 and 320 in FIG. 3 can correspond to procedure 8 in FIG. 1, for example. Moreover, the charging data request can include some or all of the information elements illustrated in FIG. 2A and FIG. 2B.

Referring to FIG. 3, the charging data request can include a satellite backhaul category corresponding to the satellite backhaul. The charging data request can further include a starting time of usage of the satellite backhaul and/or an end time of usage of the satellite backhaul.

The charging data request can include an observed satellite backhaul delay corresponding to the satellite backhaul. The observed satellite backhaul delay may have been previously received at the SMF. The observed satellite backhaul delay can be expressed as one-way delay through the satellite backhaul. The charging data request can further include a starting time of the observed satellite backhaul delay and/or an end time of the observed satellite backhaul delay.

For example, when a RAN node (e.g., gNB) is on a train and the train is in a first station, the RAN node (e.g., gNB) may rely on a terrestrial network (TN) backhaul (BH) to send data to a core network. After the train leaves the station, the train may pass through a desert where using the TN backhaul is not an option. Accordingly, at a particular time (T1) the RAN (e.g., gNB) may start to use a non-terrestrial backhaul (e.g., satellite backhaul) comprising one or more satellites in, for example, low Earth orbit (LEO). In this scenario, the non-terrestrial backhaul category (e.g., satellite backhaul category) indicates that the NTN backhaul (e.g., satellite backhaul) is a LEO satellite backhaul. Accordingly, the SMF can report a start of the satellite backhaul category, which may have 100 ms delay, with an indication that use of the satellite backhaul (e.g., the LEO satellite backhaul) began at time T1. Later, at time T2, the train may be so far into a desert that an inter-satellite link (ISL) between two satellites of the satellite backhaul may need to be used to send data from the RAN node (e.g., gNB) on the train to the core network. Thus, the SMF may report a satellite backhaul category, with a delay of (for this example) 200 ms. Later still, at T3, the train may come closer to a more populated area, and the satellite backhaul may no longer require an ISL, consequently resulting in a reduced delay, which can also be reported by the SMF to the CHF. Finally, at T4, the train may come to a station in the populated area, where a TN backhaul may be available. Thus, at T4, the SMF may report an end of the satellite backhaul category with time T4.

A start marker and an end marker can be provided to the SMF at the start of use of satellite backhaul and at the end of use of satellite backhaul, respectively. Thus, any data transferred between a timestamp of the start marker and a timestamp of the end mark can be identified as being transported over a satellite backhaul corresponding to the satellite backhaul category. The SMF can identify the start and end of the satellite backhaul category in various ways. For example, determination of the start and end of the satellite backhaul category can be based on PDU session establishment, PDU session release, and UE mobility between cells with TN backhaul and cells with NTN backhaul. Thus, certain embodiments may derive the start and end markers timestamps based on PDU session establishment, PDU session release, and UE mobility between cells with TN backhaul and cells with NTN backhaul as well as PDU session user plane (UP) becoming active/inactive.

The charging data request can include one or more QoS parameters corresponding to the satellite backhaul. For example, the one or more QoS parameters comprise at least one of throughput, latency, jitter, or error rate.

It is noted that FIG. 3 is provided as one example embodiment of a method or process. However, certain embodiments are not limited to this example, and further examples are possible as discussed elsewhere herein.

FIG. 4 illustrates an example flow diagram of a method for providing charging information related to a satellite backhaul to a session management function over an interface between the session management function and a charging function, according to certain embodiments. In some embodiments, the method of FIG. 4 may be performed by a network function such as, for example, a charging function or an apparatus implementing a charging function. A charging function may be a device of a core network. The charging function may be freely implemented as a standalone device, a blade of a multi-blade server system, or on shared hardware as one of several network functions running on the same underlying hardware.

The method of FIG. 4 may include, at 410, receiving a charging data request, such as the charging data request sent at 310 in FIG. 3. The method may also include storing data from the request at 415. The data from the request may be stored in charging data records. The data stored may include the charging data request message itself and/or the contents of one or more of the information elements from any of the fields or sub-fields shown in FIG. 2A and FIG. 2B. The method of FIG. 4 may also include, at 420, sending a charging data response, based on the charging data request. This may be the same charging data request received at 320 in FIG. 3. The charging data response can include a quota to be applied to, or that is granted to, a consumed service, which may be in units such as megabytes (MB), gigabytes (GB), or the like. The charging data response may include a credit granted to the SMF. The credit granted to the SMF may indicate that for this rating group, the UE can consume an indicated amount of MB. The charging data request message of FIG. 4 may have any or all of the characteristics of the charging data request message of FIG. 3, described above.

The method of FIG. 4 may also include, at 425, sending the charging data records to a billing engine or to a customer care engine.

It is noted that FIG. 4 is provided as one example embodiment of a method or process. However, certain embodiments are not limited to this example, and further examples are possible as discussed elsewhere herein. Moreover, the method of FIG. 3 and the method FIG. 4 may operate together and may jointly correspond to procedure 8 of FIG. 1.

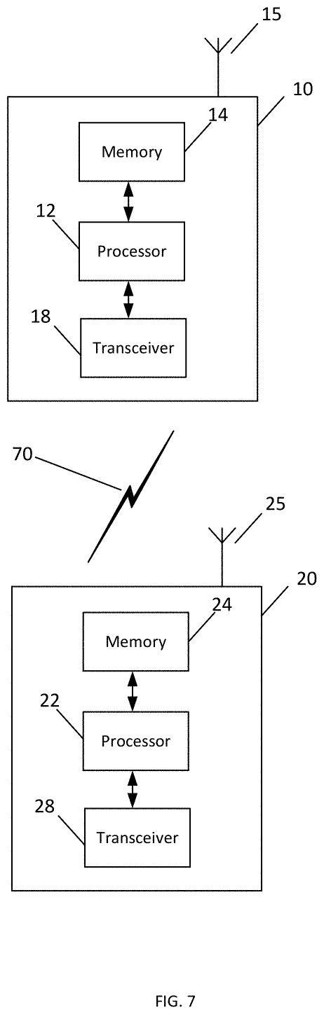

FIG. 7 illustrates an apparatus 10 that implements the method of the present disclosure, according to an embodiment. In an embodiment, apparatus 10 may be a node, server in a core network. For example, apparatus 10 may implement any of the network functions illustrated in FIG. 1, such a session management function or charging function.

It should be understood that, in some example embodiments, apparatus 10 may comprise an cloud computing system or a distributed computing system that hosts various network functions of the core network, including the SMF and the CHF. It should be noted that one of ordinary skill in the art would understand that apparatus 10 may include components or features not shown in FIG. 7.

As illustrated in the example of FIG. 7, apparatus 10 may include a processor 12 for processing information and executing instructions or operations. Processor 12 may be any type of general or specific purpose processor. In fact, processor 12 may include one or more of general-purpose computers, special purpose computers, microprocessors, digital signal processors (DSPs), field-programmable gate arrays (FPGAs), application-specific integrated circuits (ASICs), and processors based on a multi-core processor architecture, or any other processing means, as examples. While a single processor 12 is shown in FIG. 7, multiple processors may be utilized according to other embodiments. For example, it should be understood that, in certain embodiments, apparatus 10 may include two or more processors that may form a multiprocessor system (e.g., in this case processor 12 may represent a multiprocessor) that may support multiprocessing. In certain embodiments, the multiprocessor system may be tightly coupled or loosely coupled (e.g., to form a computer cluster).

Processor 12 may perform functions associated with the operation of apparatus 10, which may include, for example, precoding of antenna gain/phase parameters, encoding and decoding of individual bits forming a communication message, formatting of information, and overall control of the apparatus 10, including processes related to management of communication or communication resources.

Apparatus 10 may further include or be coupled to a memory 14 (internal or external), which may be coupled to processor 12, for storing information and instructions that may be executed by processor 12. Memory 14 may be one or more memories and of any type suitable to the local application environment, and may be implemented using any suitable volatile or nonvolatile data storage technology such as a semiconductor-based memory device, a magnetic memory device and system, an optical memory device and system, fixed memory, and/or removable memory. For example, memory 14 can be comprised of any combination of random access memory (RAM), read only memory (ROM), static storage such as a magnetic or optical disk, hard disk drive (HDD), or any other type of non-transitory machine or computer readable media, or other appropriate storing means. The instructions stored in memory 14 may include program instructions or computer program code that, when executed by processor 12, enable the apparatus 10 to perform tasks as described herein.

In an embodiment, apparatus 10 may further include or be coupled to (internal or external) a drive or port that is configured to accept and read an external computer readable storage medium, such as an optical disc, USB drive, flash drive, or any other storage medium. For example, the external computer readable storage medium may store a computer program or software for execution by processor 12 and/or apparatus 10.

In an embodiment, memory 14 may store software modules that provide functionality when executed by processor 12. The modules may include, for example, an operating system that provides operating system functionality for apparatus 10. The memory may also store one or more functional modules, such as an application or program, to provide additional functionality for apparatus 10. The components of apparatus 10 may be implemented in hardware, or as any suitable combination of hardware and software.

According to some embodiments, processor 12 and memory 14 may be included in or may form a part of processing circuitry/means or control circuitry/means. In addition, in some embodiments, transceiver 18 may be included in or may form a part of transceiver circuitry/means.

As used herein, the term “circuitry” may refer to hardware-only circuitry implementations (e.g., analog and/or digital circuitry), combinations of hardware circuits and software, combinations of analog and/or digital hardware circuits with software/firmware, any portions of hardware processor(s) with software (including digital signal processors) that work together to cause an apparatus (e.g., apparatus 10) to perform various functions, and/or hardware circuit(s) and/or processor(s), or portions thereof, that use software for operation but where the software may not be present when it is not needed for operation. As a further example, as used herein, the term “circuitry” may also cover an implementation of merely a hardware circuit or processor (or multiple processors), or portion of a hardware circuit or processor, and its accompanying software and/or firmware. The term circuitry may also cover, for example, a baseband integrated circuit in a server, cellular network node or device, or other computing or network device.

As introduced above, in certain embodiments, apparatus 10 may implement any of the network functions illustrated in FIG. 1, such a session management function or charging function. According to certain embodiments, apparatus 10 may be controlled by memory 14 and processor 12 to perform the operations of the methods described herein. For example, in some embodiments, apparatus 10 may be configured to perform one or more of the processes depicted in any of the flow charts or signaling diagrams described herein, such as those illustrated in FIGS. 1-4, or any other method described herein. In some embodiments, as discussed herein, apparatus 10 may be configured to perform the method relating to providing charging information related to a satellite backhaul over an interface to a charging function, for example.

FIG. 7 further illustrates examples apparatus 20, according to an embodiment. Apparatus 20 may be implemented in or may represent a UE, such as the UE illustrated in FIG. 1. As described herein, a UE may alternatively be referred to as, for example, a mobile station, mobile equipment, mobile unit, mobile device, user device, subscriber station, wireless terminal. A UE may be a tablet, smart phone, IoT device, sensor or NB-IoT devices, a watch or other wearable device, a head-mounted display (HMD), a vehicle, a drone, a medical device and applications thereof (e.g., remote surgery), an industrial device and applications thereof (e.g., a robot and/or other wireless devices operating in an industrial and/or an automated processing chain context), a consumer electronics device, a device operating on commercial and/or industrial wireless networks, or the like. As one example, apparatus 20 may be implemented in, for instance, a wireless handheld device, a wireless plug-in accessory, or the like.

In some example embodiments, apparatus 20 may include one or more processors, one or more computer-readable storage medium (for example, memory, storage, or the like), one or more radio access components (for example, a modem, a transceiver, or the like), and/or a user interface. In some embodiments, apparatus 20 may be configured to operate using one or more radio access technologies, such as GSM, LTE, LTE-A, NR, 5G, WLAN, WiFi, NB-IoT, Bluetooth, NFC, and/or any other radio access technologies. It should be noted that one of ordinary skill in the art would understand that apparatus 20 may include components or features not shown in FIG. 7.

As illustrated in the example of FIG. 7, apparatus 20 may include or be coupled to a processor 22 for processing information and executing instructions or operations. Processor 22 may be any type of general or specific purpose processor. In fact, processor 22 may include one or more of general-purpose computers, special purpose computers, microprocessors, digital signal processors (DSPs), field-programmable gate arrays (FPGAs), application-specific integrated circuits (ASICs), and processors based on a multi-core processor architecture, as examples. While a single processor 22 is shown in FIG. 7, multiple processors may be utilized according to other embodiments. For example, it should be understood that, in certain embodiments, apparatus 20 may include two or more processors that may form a multiprocessor system (e.g., in this case processor 22 may represent a multiprocessor) that may support multiprocessing. In certain embodiments, the multiprocessor system may be tightly coupled or loosely coupled (e.g., to form a computer cluster).

Processor 22 may perform functions associated with the operation of apparatus 20 including, as some examples, precoding of antenna gain/phase parameters, encoding and decoding of individual bits forming a communication message, formatting of information, and overall control of the apparatus 20, including processes related to management of communication resources.

Apparatus 20 may further include or be coupled to a memory 24 (internal or external), which may be coupled to processor 22, for storing information and instructions that may be executed by processor 22. Memory 24 may be one or more memories and of any type suitable to the local application environment, and may be implemented using any suitable volatile or nonvolatile data storage technology such as a semiconductor-based memory device, a magnetic memory device and system, an optical memory device and system, fixed memory, and/or removable memory. For example, memory 24 can be comprised of any combination of random access memory (RAM), read only memory (ROM), static storage such as a magnetic or optical disk, hard disk drive (HDD), or any other type of non-transitory machine or computer readable media. The instructions stored in memory 24 may include program instructions or computer program code that, when executed by processor 22, enable the apparatus 20 to perform tasks as described herein.

In an embodiment, apparatus 20 may further include or be coupled to (internal or external) a drive or port that is configured to accept and read an external computer readable storage medium, such as an optical disc, USB drive, flash drive, or any other storage medium. For example, the external computer readable storage medium may store a computer program or software for execution by processor 22 and/or apparatus 20.

In some embodiments, apparatus 20 may also include or be coupled to one or more antennas 25 for receiving a downlink signal and for transmitting via an uplink from apparatus 20. Apparatus 20 may further include a transceiver 28 configured to transmit and receive information. The transceiver 28 may also include a radio interface (e.g., a modem) coupled to the antenna 25. The radio interface may correspond to a plurality of radio access technologies including one or more of GSM, LTE, LTE-A, 5G, NR, WLAN, NB-IoT, Bluetooth, BT-LE, NFC, RFID, UWB, and the like. The radio interface may include other components, such as filters, converters (for example, digital-to-analog converters and the like), symbol demappers, signal shaping components, an Inverse Fast Fourier Transform (IFFT) module, and the like, to process symbols, such as OFDMA symbols, carried by a downlink or an uplink.

For instance, transceiver 28 may be configured to modulate information on to a carrier waveform for transmission by the antenna(s) 25 and demodulate information received via the antenna(s) 25 for further processing by other elements of apparatus 20. In other embodiments, transceiver 28 may be capable of transmitting and receiving signals or data directly. Additionally or alternatively, in some embodiments, apparatus 20 may include an input and/or output device (I/O device). In certain embodiments, apparatus 20 may further include a user interface, such as a graphical user interface or touchscreen.

In an embodiment, memory 24 stores software modules that provide functionality when executed by processor 22. The modules may include, for example, an operating system that provides operating system functionality for apparatus 20. The memory may also store one or more functional modules, such as an application or program, to provide additional functionality for apparatus 20. The components of apparatus 20 may be implemented in hardware, or as any suitable combination of hardware and software. According to an example embodiment, apparatus 20 may optionally be configured to communicate with apparatus 10 via a wireless or wired communications link 70 according to any radio access technology, such as NR.

According to some embodiments, processor 22 and memory 24 may be included in or may form a part of processing circuitry or control circuitry. In addition, in some embodiments, transceiver 28 may be included in or may form a part of transceiver circuitry.

In some embodiments, an apparatus (e.g., apparatus 10 and/or apparatus 20) may include means for performing a method, a process, or any of the variants discussed herein. Examples of the means may include one or more processors, memory, controllers, transmitters, receivers, and/or computer program code for causing the performance of any of the operations discussed herein. More particularly, when apparatus 20 implements the UE shown in FIG. 1, apparatus 20 may be configured to perform PDU session establishment with an AMF, as shown in FIG. 1.

In view of the foregoing, certain example embodiments provide several technological improvements, enhancements, and/or advantages over existing technological processes and constitute an improvement at least to the technological field of wireless network control and/or management. Certain embodiments may have various benefits and/or advantages. For example, certain embodiments may enable the capability of the SMF to trigger GTP-U path monitoring when a satellite backhaul is used. Moreover, certain embodiments may enable the capability of the SMF to report the observed delay resulting from GTP-U path monitoring to the PCF. Also, certain embodiments may enable the capability of the PCF to receive observed delay and to take the observed delay into account for policy control decisions.

In some example embodiments, the functionality of any of the methods, processes, signaling diagrams, algorithms or flow charts described herein may be implemented by software and/or computer program code or portions of code stored in memory or other computer readable or tangible media, and may be executed by a processor.

In some example embodiments, an apparatus may include or be associated with at least one software application, module, unit or entity configured as arithmetic operation(s), or as a program or portions of programs (including an added or updated software routine), which may be executed by at least one operation processor or controller. Programs, also called program products or computer programs, including software routines, applets and macros, may be stored in any apparatus-readable data storage medium and may include program instructions to perform particular tasks. A computer program product may include one or more computer-executable components which, when the program is run, are configured to carry out some example embodiments. The one or more computer-executable components may be at least one software code or portions of code. Modifications and configurations required for implementing the functionality of an example embodiment may be performed as routine(s), which may be implemented as added or updated software routine(s). In one example, software routine(s) may be downloaded into the apparatus.

As an example, software or computer program code or portions of code may be in source code form, object code form, or in some intermediate form, and may be stored in some sort of carrier, distribution medium, or computer readable medium, which may be any entity or device capable of carrying the program. Such carriers may include a record medium, computer memory, read-only memory, photoelectrical and/or electrical carrier signal, telecommunications signal, and/or software distribution package, for example. Depending on the processing power needed, the computer program may be executed in a single electronic digital computer or it may be distributed amongst a number of computers. The computer readable medium or computer readable storage medium may be a non-transitory medium.

In other example embodiments, the functionality of example embodiments may be performed by hardware or circuitry included in an apparatus, for example through the use of an application specific integrated circuit (ASIC), a programmable gate array (PGA), a field programmable gate array (FPGA), or any other combination of hardware and software. In yet another example embodiment, the functionality of example embodiments may be implemented as a signal, such as a non-tangible means, that can be carried by an electromagnetic signal downloaded from the Internet or other network.

According to an example embodiment, an apparatus, such as a node, device, or a corresponding component, may be configured as circuitry, a computer or a microprocessor, such as single-chip computer element, or as a chipset, which may include at least a memory for providing storage capacity used for arithmetic operation(s) and/or an operation processor for executing the arithmetic operation(s).

Example embodiments described herein may apply to both singular and plural implementations, regardless of whether singular or plural language is used in connection with describing certain embodiments. For example, an embodiment that describes operations of a single network node may also apply to example embodiments that include multiple instances of the network node, and vice versa.

One having ordinary skill in the art will readily understand that the example embodiments as discussed above may be practiced with procedures in a different order, and/or with hardware elements in configurations which are different than those which are disclosed. Therefore, although some embodiments have been described based upon these example embodiments, it would be apparent to those of skill in the art that certain modifications, variations, and alternative constructions would be apparent, while remaining within the spirit and scope of example embodiments.

### Partial Glossary

AMF Access and Mobility Function

CDR Charging Data Record

CHF Charging Function

NTN Non-Terrestrial Network

PCF Policy Control Function

SMF Session Management Function

UE User Equipment

UPF User Plane Function

We claim:

1. An apparatus, comprising:
at least one processor; and
at least one memory including computer program instructions,
wherein the at least one memory and the computer program instructions are configured to, with the at least one processor, cause the apparatus at least to perform:
sending a charging data request to a charging function of a core network, wherein the charging data request comprises an identifier configured to indicate that a non-terrestrial network backhaul has been used for sending data traffic from a radio access network to a core network; and
receiving a charging data response from the charging function in response to the charging data request.

2. The apparatus of claim 1, wherein the non-terrestrial network backhaul comprises a satellite backhaul and wherein the charging data request comprises a satellite backhaul category corresponding to the satellite backhaul.

3. The apparatus of claim 2, wherein the charging data request further comprises a starting of the satellite backhaul category.

4. The apparatus of claim 2, wherein the charging data request further comprises an end of the satellite backhaul category.

5. The apparatus of claim 1, wherein the charging data request comprises an observed satellite backhaul delay corresponding to the satellite backhaul.

6. The apparatus of claim 5, wherein the observed satellite backhaul delay comprises one-way delay through the satellite backhaul.

7. The apparatus of claim 5, wherein the charging data request further comprises a starting time of the observed satellite backhaul delay.

8. The apparatus of claim 5, wherein the charging data request further comprises an end time of the observed satellite backhaul delay.

9. The apparatus of claim 1, wherein the charging data request comprises one or more quality of service parameters corresponding to the satellite backhaul.

10. The apparatus of claim 9, wherein the one or more quality of service parameters comprise at least one of throughput, latency, jitter, or error rate.

11. An apparatus, comprising:
at least one processor; and
at least one memory including computer program instructions,
wherein the at least one memory and the computer program instructions are configured to, with the at least one processor, cause the apparatus at least to perform:
receiving a charging data request from a session management function of a core network, wherein the charging data request comprises an identifier configured to indicate that a non-terrestrial network backhaul has been used for sending data traffic from a radio access network to a core network; and
sending a charging data response to the session management function in response to the charging data request.

12. The apparatus of claim 11, wherein the non-terrestrial network backhaul comprises a satellite backhaul and wherein the charging data request comprises a satellite backhaul category corresponding to the satellite backhaul.

13. The apparatus of claim 12, wherein the charging data request further comprises a starting of the satellite backhaul category.

14. The apparatus of claim 12, wherein the charging data request further comprises an end of the satellite backhaul category.

15. The apparatus of claim 11, wherein the charging data request comprises an observed satellite backhaul delay corresponding to the satellite backhaul.

16. The apparatus of claim 15, wherein the observed satellite backhaul delay comprises one-way delay through the satellite backhaul.

17. The apparatus of claim 15, wherein the charging data request further comprises at least one of a starting time of the observed satellite backhaul delay or an end time of the observed satellite backhaul delay.

18. The apparatus of claim 11, wherein the charging data request comprises one or more quality of service parameters corresponding to the satellite backhaul.

19. The apparatus of claim 18, wherein the one or more quality of service parameters comprise at least one of throughput, latency, jitter, or error rate.

20. The apparatus of claim 19, wherein the at least one memory and the computer program instructions are configured to, with the at least one processor, cause the apparatus at least to perform
storing the received information in charging data records; and
sending the charging data records to a billing engine or to a customer care engine.
